(19) United States
(12) Patent Application Publication
(10) Pub. No.: US 2012/0011071 A1
(43) Pub. Date: Jan. 12, 2012

(54) Remote invoice and negotiable instrument processing

(76) Inventors: Sean Pennock, Royse City, TX (US); Eric Dotson, Rockwall, TX (US); Scott Harris, Rockwall, TX (US); Keith Reeves, Roswell, GA (US)

(21) Appl. No.: 13/068,361

(22) Filed: May 9, 2011

Related U.S. Application Data
(63) Continuation-in-part of application No. 12/803,975, filed on Jul. 12, 2010.

(51) Int. Cl. G06Q 40/00; G06Q 20/00

(52) U.S. Cl. 705/75; 705/40

(57) ABSTRACT

A method of creating an electronic invoice is provided. A mobile application is downloaded to an operating system of a wireless electronic communication device. The mobile application is capable of processing a point of sale type operation. The operating system captures information required for invoice/receipt and payment. The invoice/receipt information is created and outputted for import into an accounting system. The payment information is created and outputted for import into a payment processing system. The invoice/receipt information is created and outputted for the customer. Upon receipt of a payment, the payment is processed.

### CROSS REFERENCE TO RELATED APPLICATION

This application is a continuation-in-part of U.S. patent application Ser. No. 12/803,975 titled, “Remote Negotiable Instrument Processor” filed 12 Jul. 2011, the disclosure of which is incorporated herein by this reference.

### FIELD OF THE INVENTION

The present invention relates to processing of invoices along with the negotiable instruments, electronic payments, financial transaction cards (e.g. credit/debit/gift cards), and the like used to pay those invoices.

### BACKGROUND OF THE INVENTION

Bank checks first came into use in the late 1600s in England. Goldsmiths stored gold and silver for customers in exchange for Goldsmiths notes (also called a bill of exchange or draft). The customers could write an order to the Goldsmith to pay back a certain sum to the customer or to another person or the bearer of the note. Checks evolved from these bills of exchange. The derivation of the word ‘check’ is reported to have originated from the placing of a serial number to a bill of exchange or commercial paper as a means of verification allowing the bill of exchange to perform as a check does today.

In the United States, following the 1849 California gold rush the Wells Fargo Stage Coach Line specialized in shipping gold and silver from western mines to points east. When these shipments became subject to stage coach robberies, Wells Fargo eventually worked out correspondent relationships with eastern banks so that clearings of payments using drafts or checks eliminated the physical movement of large amounts of gold. Consequently, Wells Fargo also became a California state chartered bank.

By 1913, the United States had 48 states and the check had become an accepted form of payment. But as the volume of checks grew, a check deposited at a bank on one coast could take weeks to be paid. That year the Federal Reserve Act established the Federal Reserve System, often referred to as the Federal Reserve or simply “the Fed”. The Federal Reserve System is the central bank of the United States. Congress created the Federal Reserve System to provide the nation with a safer, more flexible, and more stable monetary and financial system. The Federal Reserve System is basically composed of a central, governmental agency—the Board of Governors—and twelve regional Federal Reserve Banks, located in major cities throughout the nation. The seven members of the Board of Governors are nominated by the President of the United States and confirmed by the U.S. Senate.

The Fed member banks kept their reserves with their district Fed, which could pool them and extend credit to member banks under certain conditions. As a result, the clearing of checks with the nationwide Federal Reserve Bank clearing system shortened the clearing times and reduced excessive exchange charges for checks.

By 1952, there were 47 million checking accounts with 8 billion checks written annually. The average check passed through 2.3 banks and required 2.3 business days to be presented and collected. Therefore, on an average business day, there were 69 million checks in process throughout the payments system. These paper checks were manually handled and sorted based on the bank routing number in fraction form printed in the upper right hand area of the check. The sheer volume of paper was threatening to crush the banking system. In April 1954, the Bank Management Commission of the American Bankers Association formed a Technical Committee on Mechanization of Check Handling to study the problem and recommend a common machine language for the possible automation of the paper based payments system.

The Technical Committee began working with various machine manufacturers and over a period of two years studied carrier systems with the data encoded on a surface attached to or wrapped around the check, and non-carrier systems consisting of codes or patterns and Arabic characters readable by machine or by the human eye. The Technical Committee reviewed magnetic ink binary or bar codes with miniature bar codes on the reverse side of the check, fluorescent spot codes, and Arabic character systems, some using conventional printer's ink and others using magnetic inks.

In July 1956, the Technical Committee published Document 138, Magnetic Ink Character Recognition The Common Machine Language for Check Handling. The committee recommended magnetic ink character recognition (MICR) based on the advantages of having a machine readable language which also was easily readable by humans; the relative insensitivity of the magnetic ink signals to mutilation, and a demonstrated feasibility. Following this, the major machine manufacturers, representatives of the printing industry, and the Federal Reserve System unanimously indicated their concurrence of MICR as the common machine language for mechanized check handling.

During the first OEM Committee meeting, in September 1956, Dr. Kenneth R. Eldredge of the Stanford Research Institute presented his work on magnetic character recognition on behalf of General Electric. Dr. Eldredge filed for a patent on Automatic Reading System on 6 May 1955 and was granted U.S. Pat. No. 3,000,000 on 12 Sep. 1961. Because of their early state of the art work in magnetic ink recognition, the Stanford Research Institute, the Bank of America, and GE were heavily involved in submitting and evaluating many of the fonts which were submitted to the Type Design Committee.

The next step was to determine the actual location and format of the fields of the common machine language. Areas adjacent and parallel to either the top or bottom edge of a check were considered. Reasons advanced in favor of the bottom edge were fewer mutilations, economy in equipment and operation, and greater customer acceptance. The one reason advanced in favor of the top edge was the apparent difficulty of adapting bottom edge encoding to punch card checks which were in common use. The preference ultimately was for the bottom edge. Compatibility with the 80 column punch card was reached with recognition that only the left most 50 columns could utilize the 9's punched hole positions as long as the pre-printed MICR information was positioned parallel and adjacent to the bottom edge of the punch card. Post printing or encoding for these checks would be at the same location designated for all other types of checks.

In April 1957, the Technical Committee on Mechanization of Check Handling published in Document 141 their recommendations on Placement for the Common Machine Language on Checks. In January 1958, the ABA Technical Committee released publication 142, Location and Arrangement of Magnetic Ink Characters for the Common Machine Language on Checks. This report covered the fields on items to be encoded, the number of digits allotted to each, and the sequence of the information.

In July 1958, A Progress Report: Mechanization of Check Handling published as Publication 146 specified the clear printing areas on the check and announced the field evaluation test for the E-13A type font. The Type Design Committee engaged Batelle Memorial Institute to administer the details of the trial printing and machine readability of the font. Battelle acted as a clearing house for instructions and received unidentified printing batches and forwarded them to machine companies for evaluation. The readability results were compiled by Battelle and presented in a report. Finally, in November 1958, the Type Design Committee agreed on a change in the Transit symbol and a relaxation of the void specification.

The “E” in the designation E-13B stands for the 5th letter of the alphabet, which signifies 5 numerical type fonts or styles of type that were studied starting with the letter A. The “13” means the 0.013 inch grid that constitutes the matrix of the font. Each character has segments which are multiples of the 0.013 inch grid. The “B” stands for a modification of the 5th type font: with the E-13A font, a problem was noted as the transit symbol was sometimes misread as a character 8; the transit symbol was changed and the type font was then designated as E-13B.

Concurrently with the font development, the problem of format was resolved, and in April 1959 the Bank Management Commission of the American Bankers Association published Document 147, The Common Machine Language for Mechanized Check Handling: Final Specifications and Guides to Implement the Program. In December 1959, the Bank Management Commission of ABA released Publication 149, which relaxed additional tolerances and provided clarification of others. These changes were incorporated into 147R, which was released in February 1962. Publication 147R was revised two more times with the release of Publication 147R3 in 1967.

The Standards Committee on Computers and Information Processing, X3, with the Business Equipment Manufacturers Association as Secretariat, recognized the desirability of issuing the E-13B work as an American National Standard. Thus, the Standards Committee formed the X3-7 Subcommittee on MICR and, with the assistance of the X3-7-1 technical group, issued 2 related standards on MICR in 1963 as ANSI X3.2-1963, American National Standard: Print Specifications for Magnetic Character Ink Character Recognition and ANSI X3.3-1963, American National Standard: Bank Check Specifications for Magnetic Ink Character Recognition. Much of the information presented in those first Standards was taken from Publication 147. Meanwhile, the X3 committee kept X3-7 active and endorsed X3-7's participation in the International Organization for Standardization, Technical Committee 97, Subcommittee 3 (ISO/TC 97/SC3) on Character Recognition.

After a series of international meetings terminating in 1965, the ISO Recommendation R 1004-1969, Print Specification for Magnetic Character Recognition, was published. This recommendation contained the E-13B specifications in addition to another MICR character set known internationally as CMC-7. By 1968, the American Bankers Association deferred the publication of 147R3 and future revisions to the American National Institute, and both Standards X3.2 and X3.3 were revised again in 1970 and re-affirmed in 1976. In 1982, X3 assigned responsibility for the maintenance of X3.2-1970 and X3.3-1970 to its Subcommittee X3A1, Character Recognition. In 1983, X3A1 enlisted the assistance of American National Standards Committee, Financial Services—X9, and its Subcommittee, X9B (Paper Based Transactions), in order that a detailed review of X3.2-1970 and X3.3-1970 could be accomplished with input from all interested groups. In 1983, X3 approved transfer of X3.3 to X9 with the publication of X9.13-1983, American National Standard Specifications for Placement and Location of MICR Printing. In 1987, X3 approved the transfer of X3.2 to X9 and the revision of that publication became X9.27-1988, American National Standard for Magnetic Ink Character Recognition.

Meanwhile the ASC X9 Subcommittee, X9B, was growing because of a renewed interest in checks. Those who forecast the demise of checks in the 1980's as being replaced by electronic funds transfer were proven wrong as check volume continued to climb throughout the 1980's at 5-8% compounded annual growth rate. Membership in X9B continually increased as the following standards were developed: Specifications for Check Endorsements, X9.3; Bank Check Background and Convenience Amount Field, X9.7; Paper Specifications for Checks, X9.18; X9 Technical Guideline for Understanding and Designing Checks, X9/TG-2; Check Carrier Envelope Specification, X9.29; Legibility Specifications for Endorsements, X9.36; Extension Strip Specification, X9.40; X9 Technical Guideline: Quality Control of MICR Documents, X9/TG-6; and X9 Technical Guideline Check Security Guidelines, X9/TG-8.

In 1995, ANSI X9.46, American National Standard for Financial Image Interchange: Architecture, Overview, and System Design Specification was introduced, which permitted electronic check presentment with image send or subsequent image store/forward systems and image query and retrieval on demand. This enabled financial institutions to reduce transportation costs of paper documents and improve the speed of return of unpaid items image check documents in order to improve customer service, automate proof-of-deposit functions, enable image reconciliation of in-clearings and provide image statements.

The process of removing the paper check from its processing flow is called truncation. In truncation, both sides of the paper check are scanned to produce digital images. If a paper document is still needed, these images are inserted into specially formatted documents containing a photo-reduced copy of the original checks called a “substitute check”. Once a check is truncated, businesses and banks can work with either the digital image or a print reproduction of the check. Images can be exchanged between member banks, savings and loans, credit unions, servicers, clearinghouses, and the Federal Reserve Bank.

At the item processing center, the checks are sorted by machine according to the routing/transit (RT) number as presented by the MICR line, and scanned to produce a digital image. A batch file is generated and sent to the Federal Reserve Bank or presentment point for settlement or image replacement. If a substitute check is needed, the transmitting bank is responsible for the cost of generating and transporting it from the presentment point to the Federal Reserve Bank or other corresponding bank.

In 2000 the Federal Reserve Board staff began investigating a concept of default check truncation rules that is now called the Check Clearing for the 21^{st} Century Act or “Check 21”. The goals of the Check 21 initiative were to enable a financial institution to substitute a machine-readable copy of a check for the original check for forward collection or return. These “substitute checks” are the legal and practical equivalent of the original check.

On 21 Dec. 2001, the Chairman of Board of Governors sent a legislative proposal to the Chairs and Ranking Members of the Senate and House Banking Committees. Both the House and Senate introduced bills in the 107^{th} Congress, and in the 108^{th} Congress the House introduced H.R. 1474 while the Senate introduced S. 1334. On 8 Oct. 2003 the Act passed House of Representatives unopposed. On 14 Oct. 2003, the Act was passed in the Senate by unanimous consent. President Bush signed the bill into law on 28 Oct. 2003. The effective date was 12 months after enactment, which was 28 Oct. 2004.

Check 21 also spawned a new bank treasury management product known as remote deposit. This process allows depositing customers the ability to capture front and rear images of checks along with their respective MICR data for those being deposited. This data is then uploaded to their depositing institution, and the customer's account is then credited. Remote deposit therefore precludes the need for merchants and other large depositors to travel to the bank (or branch) to physically make a deposit.

In addition to remote deposit, other such electronic depositing options are available to qualifying bank customers through NACHA—The Electronic Payments Association. These options include “Point of Purchase” (POP) for retailers and “Accounts Receivable Conversion” (ARC) for high volume remittance receivers. These transactions are not covered under the Check 21 legislation, but rather are electronic conversions of the checks MICR data into an ACH (Automated Clearing House) debit. This can help the depositor save on the costs of transporting checks and in bank fees.

Recently, Check 21 software providers have developed a “Virtual Check 21” system which allows online and offline merchants to create and submit demand draft documents to the bank of deposit. This process which combines remotely created checks (RCC) and Check 21×9.37 files enables merchants to benefit from direct merchant-to-bank relationships, lower NSFs, and lower chargebacks.

In contrast to bank checks, the modern credit card is a more recent innovation. The modern credit card was first used in the 1920's, in the United States, specifically to sell fuel to a growing number of automobile owners. In 1938, several companies started to accept each other's cards. Western Union began issuing charge cards to its frequent customers in 1921. Some charge cards were printed on paper card stock, but were easily counterfeited.

Farrington Manufacturing Co.'s Charga-Plate, developed in 1928, was an early predecessor to the credit card used in the U.S. from the 1930s to the late 1950s. It was a 2½×1¼″ rectangle of sheet metal. The Charga-Plate was embossed with the customer's name, city and state. It held a small paper card for a signature. In recording a purchase, the plate was laid into a recess in the imprinter, with a paper “charge slip” positioned on top of it. The record of the transaction included an impression of the embossed information, made by the imprinter pressing an inked ribbon against the charge slip. Charga-Plates were issued by large-scale merchants to their regular customers, much like department store credit cards of today. Charga-Plates speeded back-office bookkeeping that was done manually in paper ledgers in each store, before computers.

The concept of customers paying different merchants using the same card was implemented in 1950 by Ralph Schneider and Frank McNamara, founders of Diners Club, to consolidate multiple cards. The Diners Club produced the first “general purpose” charge card, and required the entire bill to be paid with each statement. That was followed by Carte Blanche and in 1958 by American Express which created a worldwide credit card network.

However, until 1958, no one had been created a working revolving credit financial instrument issued by a third-party bank that was generally accepted by a large number of merchants (as opposed to merchant-issued revolving cards accepted by only a few merchants). In September 1958, Bank of America launched the BankAmericard. BankAmericard became the first successful recognizably modern credit card, and eventually evolved into the Visa system. In 1966, the ancestor of MasterCard was born when a group of California banks established Master Charge to compete with BankAmericard.

Despite the widespread modern use of checks and financial cards (i.e. credit cards, debit cards, etc.), use for field-based personnel remains problematic. Currently, field-based personnel (merchants or service people that typically work away from their office) have limited options for creating invoices and processing payments made to them. The processes are very manual and require additional work to be performed at a later time to properly process and account such payments. This results in additional manpower and processing times at a later timeframe to perform such transactions.

To manually create invoices in a remote environment is a very tedious and inefficient process. There are large margins of errors to contend with, and most times the invoices are then manually entered into the companies accounting software solution at a later time. This creates redundant data entry processes and even more chances for errors. Once the invoice is created, payment receipt has to be effectuated. If a payment is made by any method other than cash, subsequent steps have to be taken to process them accordingly. This often results in a delay in the business receiving payment. The payment then has to be recorded manually into the business's accounting software solution and processed in the appropriate manner to receive credit for the payment. This could be depositing a paper check into the business's bank or receiving credit for a financial card-based transaction.

Field-based personnel must be able to easily create invoices and receive payments from their customers without being encumbered by hardware, software or processes that cause them to create and capture information incorrectly or take too much time setting up the required equipment. Most of these field-based personnel work for small businesses and require quick access to the accounts receivable monies to operate in a positive cash-flow fashion.

Carrying a laptop computer with a large check image scanner is problematic. It is much more expensive, because each field-based user must be equipped with a laptop and scanner, so the equipment costs alone can be in the thousands of dollars, not including the software required to run each device. The image and data captured from the check are typically better quality and are more reliable than the data captured from a picture, but the solution is very clumsy to use while on the road. For example, finding a reliable power source for the scanner is an issue, because most field-based personnel operate out of the vehicles and do not have any way to provide the power needed to operate the scanner.

What would thus be desirable would be a system by which field-based personnel could quickly, efficiently, and securely capture the data necessary from checks and financial cards to process a payment as soon as it has been received from the customer. It would also be desirable to do so without having to create a new payment silo at the financial institution.

### SUMMARY OF THE INVENTION

A method of creating an electronic invoice in accordance with the principles of the present invention enables field-based personnel to quickly, efficiently, and securely capture the data necessary from checks and financial cards to process a payment as soon as it has been received from the customer. A method of creating an electronic invoice in accordance with the principles of the present invention does so without having to create a new payment silo at the financial institution. In accordance with the principles of the present invention, a method of creating an electronic invoice is provided. A mobile application is downloaded to an operating system of a wireless electronic communication device. The mobile application is capable of processing a point of sale type operation. The operating system captures information required for invoice/receipt and payment. The invoice/receipt information is created and outputted for import into an accounting system. The payment information is created and outputted for import into a payment processing system. The invoice/receipt information is created and outputted for the customer. Upon receipt of a payment, the payment is processed.

### BRIEF DESCRIPTION OF THE DRAWINGS

FIG. 1 is a perspective view of an example mobile phone, tablet device or the like processing an example negotiable instrument, electronic payment, financial transaction cards (e.g. credit/debit/gift card) or the like.

FIG. 2 is a flow-chart showing a process that can be utilized to use the example device of FIG. 1 to capture the magnetic data from a negotiable instrument, electronic payment, financial transaction cards (e.g. credit/debit/gift card) or the like.

FIG. 3 shows a screen shot of an example user interface that can be utilized to implement the FIG. 2 process.

FIG. 4 shows the screen shot of FIG. 3 at a different point in the FIG. 2 process.

FIG. 5 shows the screen shot of FIG. 3 at a different point in the FIG. 2 process.

FIG. 6 shows the screen shot of FIG. 3 at a different point in the FIG. 2 process.

### DETAILED DESCRIPTION OF A PREFERRED EMBODIMENT

Today there are electronic options available for both the creation of invoices and the electronic processing of non-cash payments. The present invention helps marry these two processes together and eliminates the need for manual input into a business' accounting software solution. The present invention achieves this by utilizing a mobile smart phone or tablet device to electronically create the appropriate invoice for the product/service delivered by a business. The present invention also allows for the capture or creation of check, electronic, cash, and card-based transactions to allow for the expedited deposit and credit of such payments into the business' bank account. The creation and delivery of the electronic invoice and payment details for import into third-party accounting software solutions is provided. By eliminating the need for redundant manual processing of each process, finalization of transactions can be streamlined and input errors reduced. Benefits are derived from the simplification of existing processes and enabling Field-based personnel to finalize the steps with the customer at the point of sale, without having to create a new payment silo at the financial institution. The Check 21 legislation provided the ability for financial institutions to present a substitute check in lieu of the actual check and opened the door for many different types of remote deposit. Subsequent legislation has paved the way for financial institutions to use the information contained on the check to convert the payment from to other types of payments, such as automated clearing house (ACH) transactions.

In accordance with the principles of the present invention, apparatus and methods are provided to enable merchants to create electronic invoices, and to create, capture, and process payments using a wireless electronic communications device such as a mobile phone, tablet device, and the like. The process allows individuals to utilize a mobile application as part of a process to create electronic invoices, and collect and process payments through an electronic payments hub. The process can also provide the ability to export this created and captured data to third-party accounting software applications. Various types of payments can be captured or created and processed through the present invention. These include, for example, negotiable instruments, electronic payments, financial transaction cards (e.g. credit/debit/gift cards), cash and the like. Thus, the present invention automates the invoice and payment process to eliminate the need for manual processing of billing, receiving payment, and the labor intensive input of the information accumulated to be manually entered into a third-party accounting software package.

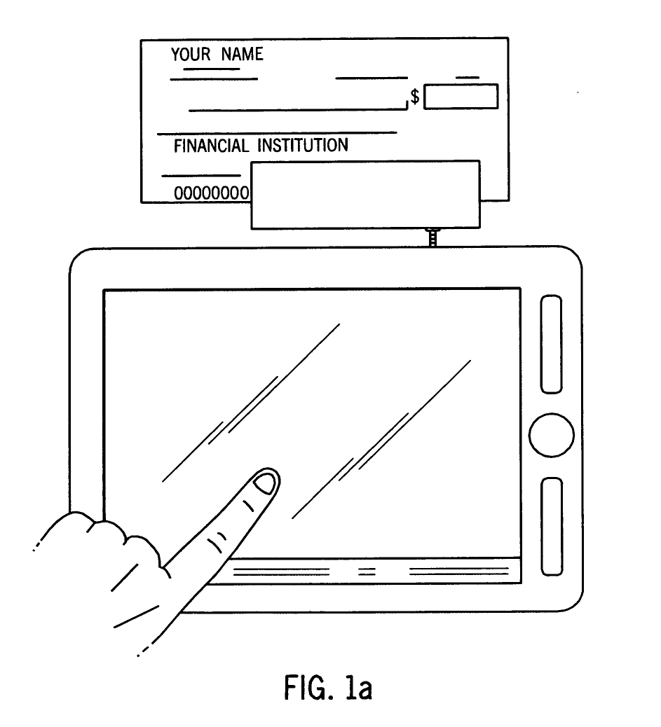

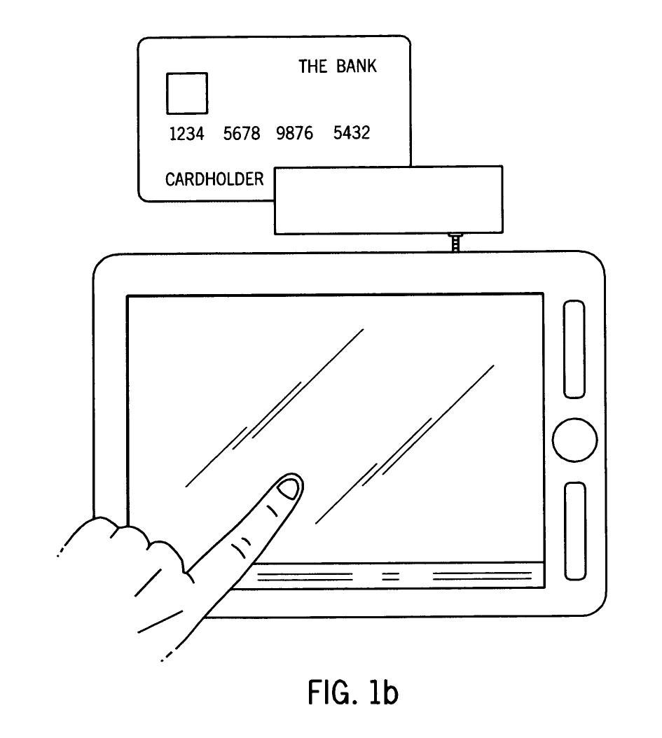

Referring now to FIG. 1, an example mobile phone, tablet device or the like 21 is seen processing an example negotiable instrument, electronic payment, financial transaction cards (e.g. credit/debit/gift card) or the like 23. A small, portable electronic device 10 can be provided to facilitate the capture of some payment data, such as for example the ISO/IEC 7813 magnetic strip on financial transaction cards and the Magnetic Ink Character Recognition (MICR) data information present on negotiable instruments. Such a device is described in detail in U.S. patent application Ser. No. 12/803,975 titled, “Remote Negotiable Instrument Processor” filed 12 Jul. 2011, which is assigned to the assignee of the present application, the disclosure of which is incorporated herein by this reference.

The example device 10 is adapted to be used with a standard mobile phone, tablet device or the like. The device 10 includes as an input device a magnetic strip reader 12 and as an output channel an audio jack 14. The audio jack 14 can be plugged into the audio port 23 currently in use as the standard on almost all mobile phone, tablet device or the like 21. In a preferred embodiment, the negotiable instrument, electronic payment, financial transaction cards (e.g. credit/debit/gift card) or the like can be swiped in either direction through the magnetic strip reader 12, allowing the user to easily use the device 10 in any configuration with either hand. Other devices can be used to process other types of payments. For example, the credit card reader from Square, Inc., 901 Mission Street, San Francisco, Calif. 94103 can be used to process card payments, and the camera on the mobile phone, tablet device or the like can be used to take a picture of a check for processing.

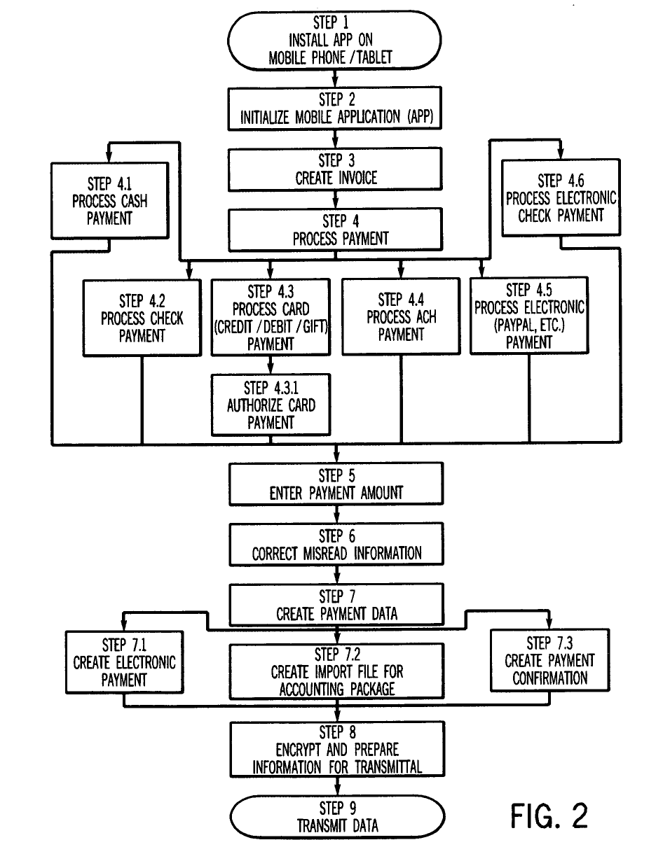

Referring now to FIG. 2, a flow-chart is seen showing a process that can be utilized to use the example device of FIG. 1 to capture the magnetic data from a negotiable instrument, electronic payment, financial transaction cards (e.g. credit/debit/gift card) or the like. In step 1a mobile application comprising the present invention is downloaded to the operating system of a mobile phone, tablet device or the like. Examples of suitable operating system include Symbian platform administered by the Symbian Foundation Limited, 1 Boundary Row, Southwark, London, SE1 BHP, U.K.; iPhone OS from Apple Inc., 1 Infinite Loop, Cupertino, Calif. 95014; Palm WebOS from Palm, Inc., 950 West Maude Avenue, Sunnyvale, Calif. 94085; BlackBerry OS from Research In Motion Limited, 295 Phillip Street, Waterloo, Ontario Canada N2L 3W8; Windows Mobile from Microsoft Corporation, 4200 150th Avenue NE, Redmond, Wash. 98052; and Android from Google Inc., 1600 Amphitheatre Pkwy, Mountain View, Calif. 94043.

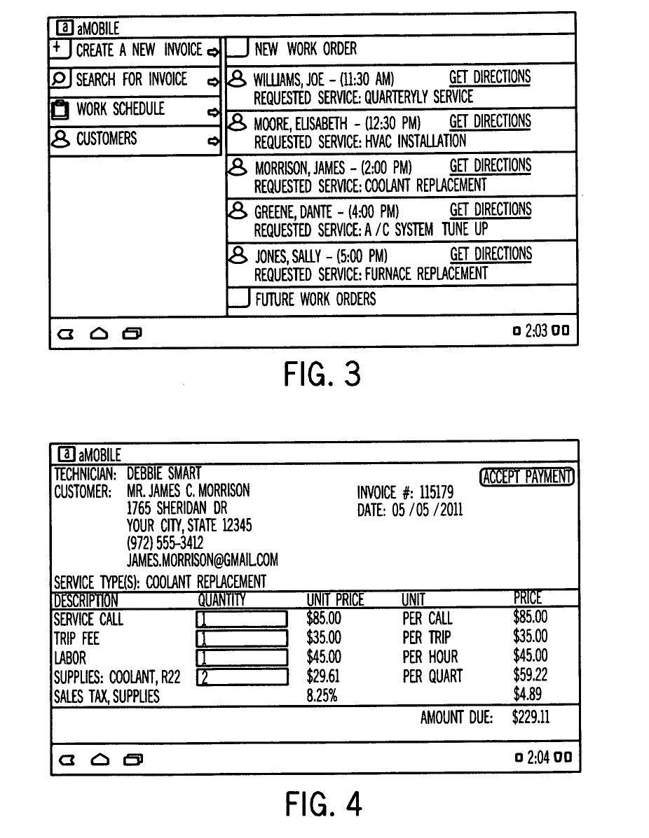

In step 2 the mobile application is initialized. Referring to FIG. 3, a screen shot of an example user interface is seen corresponding to this step 2. After the mobile application has been installed on the device, a user starts the mobile application and asks the customer for credentials before beginning the session. When the user enters the correct credentials, the mobile application starts the local session (i.e. no connection has yet been made with the server).

In step 3, information from the accounting system is imported into the mobile application. This information can either be pulled from the server to the device or pushed from the server to the device depending on the technology in use by the user of the mobile application. The present invention uses this information to determine which data should be displayed to the user. Configuration of this display information will be performed by individual(s) who have the appropriate user rights to do so. These individual(s) may configure this information using the present invention or a secure webpage via the Internet.

In step 4 an invoice is created. Referring to FIG. 4, a screen shot of an example user interface is seen corresponding to this step 4. When the local session has successfully started, the present invention allows the user to create an electronic invoice utilizing pre-configured data such as, for example, customer information, item/service items, and various other items. Configuration of item/service information will be performed by individuals who have the appropriate user rights to do so. These individual(s) may configure this information using the present invention or a secure webpage via the Internet. If pre-configured data is not available, then the user can input new information for either first-time use (for repeat customers) or single use for one-time customers.

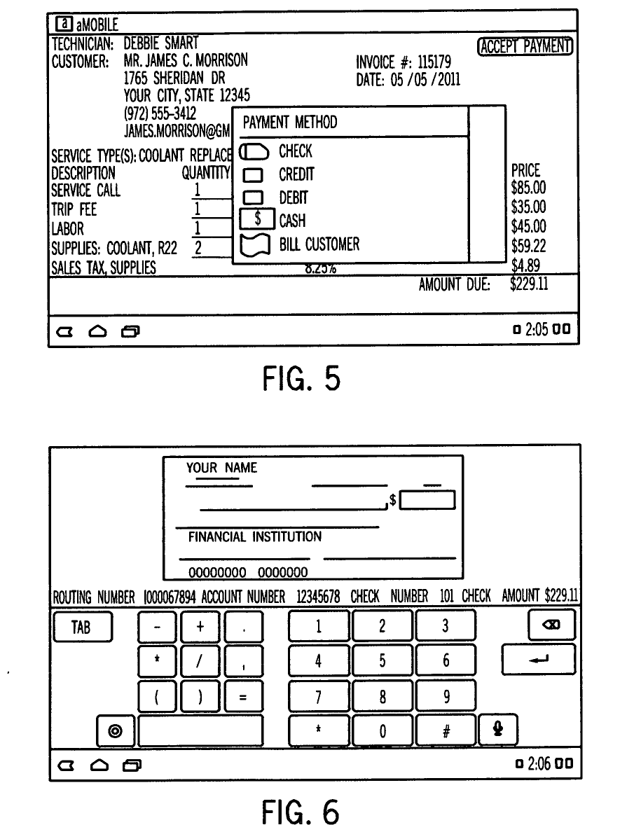

In step 5 the payment is processed. Referring to FIG. 5, a screen shot of an example user interface is seen corresponding to this step 5. Once the invoice is created, if a negotiable instrument payment is received, then the process proceeds to step 5; if a card payment is received, then the process proceeds to step 5.3. In the event a cash payment is received, the application will allow the user to denote cash as the method of payment. In step 5.1 a cash payment is processed. If cash is present, the user selects the cash option and completes the transaction on the present invention. An invoice is transmitted to the customer and the processing office showing that the transaction was completed with a cash payment.

In step 5.2 a negotiable instrument payment is processed. When a customer chooses to pay the invoice by negotiable instrument, the data may be swiped using an electronic input device attached to the mobile device or captured by taking a picture of the negotiable instrument using the camera on the mobile phone or tablet. After the negotiable instrument has been swiped or photographed, the present invention accepts and parses the MICR information consisting of financial institution routing number, customer account number, serial (check) number, and any other information present into the following data elements: AuxOnus, serial number, routing transit, account number, and amount (if included in the MICR line). Once all required fields are completed, the present invention will prompt to complete the transaction. A copy of the invoice is transmitted electronically and routed through to the customer and the processing center via for example the PayLOGICS system available from Aptys Solutions, LLC, 2095 Summer Lee Drive, Suite 200, Rockwall, Tex. 75032, the assignee of the present application.

In step 5.3 a financial card (e.g. credit/debit/gift) payment is processed. When a customer chooses to pay the invoice by financial card (e.g. credit/debit/gift), the data may be swiped using an electronic input device attached to the mobile device. After the card has been swiped, the present invention uses the session to accept and parse the information into card number, name on card, account number, and expiration data. Once the card information is captured, the present invention will prompt to complete the transaction. The card information is routed to the appropriate card clearing company's card application programming interface (API). The system will wait to receive an authorization code from the card clearing company, which authorization code is added to the electronic invoice. A copy of the invoice is transmitted electronically and routed to the customer and the processing center, via for example the PayLOGICS system.

In step 5.4 an ACH (Automated Clearing House) payment is processed. When ACH payment is selected, the present invention will open an electronic form with the appropriate fields required to create an Electronic Payments Association NACHA formatted debit transaction utilizing the Web Initiated-Entry (WEB) Standard Entry Class (SEC) Code. The WEB SEC Code was expanded in 2010 to include transactions initiated or approved using a mobile device and transmitted via a wireless network. Once the form is completed and authorization is given, the present invention will transmit the payment electronically via for example the PayLOGICS system. Fields can include customer name, receiving Depository Financial Institution ID (or routing and transit number), customer account number, and amount. A copy of the invoice or authorization is provided to the customer either electronically or physically.

In step 5.5 an electronic negotiable instrument payment can be processed. An electronic negotiable instrument payment option follows the same steps as outlined above in Step 5.2 above, with one change. Rather than starting with a negotiable instrument as a source document, the customer inputs the required fields manually to create an electronic representation of a negotiable instrument that will be presented to the paying bank as an electronic negotiable instrument.

If a check is used for the payment, the information can be captured in multiple ways including a MICR reader plugged into the mobile device to capture routing and transit and account information (as detailed in Section 4.2 above), by taking a picture of the check or by entering the information by hand, a user can complete the form with the required information and then present to the customer a screen for authorization using an electronic signature. Once the form is completed and authorization is given, the present invention will transmit the payment electronically via for example the PayLOGICS system. Referring to FIG. 6, a screen shot of an example user interface is seen corresponding to this step. Fields include customer name, receiving Depository Financial Institution ID (or routing and transit number), customer account number, and amount. A copy of the invoice or authorization is provided to the customer either electronically or physically. Once the check information has been received in the PayLOGICS system, the PayLOGICS business rules will determine whether to process the payment as a check or as an ACH transaction.

If a commercial payment system such as PayPal provided by PayPal, Inc., 2211 North First Street, San Jose, Calif. 95131 is selected, in step 5.5 the present invention will format a request that goes to the commercial payment system to manage the payment. The present invention will send the request to commercial payment system, which will forward an email message to the customer requesting they log into their account to complete the transaction. In the PayPal example, PayPal offers several ways to pay including through a PayPal account balance, ACH debit, or credit card. Once the customer has completed the authorization for payment, an email is sent back to the user confirming payment. The user can finalize the transaction by transmitting a copy of the invoice records to the customer.

Continuing to refer to FIG. 6, in step 6 the payment amount is entered. The present invention will prompt the user to enter the amount of the payment (in for example dollars and cents). A user interface shows the amount being entered, so the user can visually verify that the correct amount is entered

In step 7 the user is prompted to correct any misread information. The present invention validates the information, and asks the user to correct any information containing either misread characters or characters that could not be read at all. A user interface shows what fields or information is incorrect, and also shows the corrected characters being entered, so the user can verify that that correct information is input.

In step 8 payment data is created. In step 8.1 Electronic Payment is created. Once the payment data is captured and confirmed to be correct, the appropriate electronic is queued for preparation and transmittal. In step 8.2 an import file for accounting package is created. At any time, a user with the appropriate credentials may utilize a secure webpage on the server to retrieve any available invoices, payment, and deposit information that has been entered. These files can be downloaded in various formats that adhere to standard specification published by various third-party accounting software applications.

Standard accounting systems offer an application programming interface (API) that allow for the proper formatting and automated exchange of data between systems. The present invention utilizes will use these API's to automate the exchange of data with the designated accounting system. Formats can include (but are not limited to) Immediate if (IIF), eXtensible Markup Language (XML), and comma separated values (CSV). The format will be driven by the accounting system used and the exchange interface required by the particular system. Electronic data interchange (EDI) information may flow from the present invention to the accounting system (in the form of invoices and payments) and from the accounting system to the present invention in the form of customer information, product and services lists, and pricing information. This functionality helps reduce or eliminate the need to manually re-key information and duplication of tasks, and avoid errors and costly charge-backs. In the event a standard format is not available, the files will be available in various standard formats (comma delimited, .csv, etc.). In step 8.3 payment confirmation is created. A copy of the derived invoice with the appropriate payment confirmation is created for mobile printing or electronic e-mail delivery at this time. The user may elect which method of delivery is preferred.

In step 9, captured information is encrypted and prepared for transmittal. The present invention encrypts the data and prepares it for transmittal. Depending on the server application in use, the information may be transmitted immediately or “batched” together with other information for transmittal at the appropriate time. At the end of predetermined deadlines the host server application creates a valid transmission file for delivery to the appropriate financial institution in the appropriate format. These may include electronic check files (X9.37) or converted ACH files.

In step 10 data is transmitted. At this point payment files are prepared and ready for delivery to the financial institution(s) of choice. Thus, the present invention created and processed an invoice, payment, and export.

It should be understood that various changes and modifications preferred in to the embodiment described herein would be apparent to those skilled in the art. Such changes and modifications can be made without departing from the spirit and scope of the present invention and without demising its attendant advantages. It is therefore intended that such changes and modifications be covered by the appended claims.

What is claimed is:

1. A method of creating an electronic invoice comprising:
downloading to an operating system of a wireless electronic communication device a mobile application capable of processing a point of sale type operation, the operating system comprising being capable of;
capturing the information required for invoice/receipt and payment;
creating and outputting the invoice/receipt information for import into an accounting system;
creating and outputting the payment information for import into a payment processing system;
creating and outputting the invoice/receipt information for the customer; and,
upon receipt of a payment, processing the payment.

2. The method of creating an electronic invoice of claim 1 further comprising once the electronic invoice is created and a negotiable instrument payment is received, processing the payment by electronically transmitting and routing the electronic invoice to the customer and a processing center.

3. The method of creating an electronic invoice of claim 2 further comprising once the electronic invoice is created and a financial card payment is received, processing the payment by electronically routing the invoice to a card clearing company's card application programming interface, receiving an authorization code from the card clearing company, adding the authorization code to the electronic invoice, and electronically transmitting and routing the electronic invoice to a customer and a processing center.

4. The electronic method of creating an electronic invoice of claim 2 further comprising once the electronic invoice is created an automated clearing house (ACH) payment is received, processing the payment by opening an electronic form with the appropriate fields required to create an Electronic Payments Association NACHA formatted debit transaction, and electronically transmitting and routing the electronic invoice to the customer.

5. The method of creating an electronic invoice of claim 2 further comprising once the electronic invoice is created and a cash payment is received, processing the payment by transmitting the electronic invoice to the customer and showing that the transaction was completed with a cash payment.

6. The method of creating an electronic invoice of claim 2 further comprising once the electronic invoice is created and a check payment is received, processing the payment by electronically routing the check payment to a clearing institution's electronic exchange system with appropriate fields required for a check transaction; and, once the payment is received in the electronic exchange system, the electronic exchange system business rules will determine whether the payment will be processed as a check or an automated clearing house (ACH) transaction.

7. The method of creating an electronic invoice of claim 2 further comprising once the electronic invoice is created and the information for an electronic payment order (EPO) is received, processing the payment by electronically routing the electronic payment order (EPO) to a clearing institution's electronic exchange system with appropriate fields required for an electronic payment order (EPO) transaction.

8. The method of creating an electronic invoice claim 1 further including, before reading the payment data, requiring user credentials.

9. The method of creating an electronic invoice of claim 1 further including allowing a user to correct information containing either misread characters or characters that could not be read.

10. The electronic method to capture of data to create an electronic invoice of claim 1 further comprising, prior to electronically transmitting the electronic invoice, encrypting the data.

11. The method of creating an electronic invoice of claim 1 further comprising exporting data to third-party accounting software applications.

12. The method of creating an electronic invoice of claim 1 further comprising captured data from the group consisting of negotiable instruments, electronic payments, financial transaction cards, and combinations thereof.

13. The method of creating an electronic invoice of claim 12 further comprising captured magnetic data from the group consisting of credit cards, debit cards, gift cards, and combinations thereof.

14. The method of creating an electronic invoice of claim 12 further comprising captured magnetic data with a wireless electronic communications device selected from the group consisting of mobile phones, tablet devices, and combinations thereof.

15. The method of creating an electronic invoice of claim 1 further including further comprising as an input device, which will be a magnetic ink character recognition (MICR) reader capable of reading E-13B MICR font, a credit card processing device capable of reading the information stored on the card, or a method for capturing the required information via the mobile application's user interface.

16. A method to capture magnetic payment to create an electronic invoice comprising:
reading magnetic ink character recognition data with a magnetic reader for check payments;
reading magnetic information from credit or debit cards for card payments;
inputting data required to create an automated clearing house (ACH) transaction;
inputting data required to create an electronic payment order (EPO) transaction;
inputting data required to process a cash transaction;
creating an electronic invoice;
if the amount of payment is not included in the magnetic data, entering the payment amount; and
upon receipt of a payment, processing the payment through an electronic payment hub.

17. The method to capture of magnetic data to create an electronic invoice of claim 16 further comprising, once the electronic invoice is created and a payment is received, processing the payment by electronically transmitting and routing the electronic invoice to a customer and a processing center.

18. The method to capture of magnetic data to create an electronic invoice of claim 17 further comprising, once the electronic invoice is created and a financial card payment is received, processing the payment by electronically routing the invoice to a card clearing company's card application programming interface, receiving an authorization code from the card clearing company, adding the authorization code to the electronic invoice, and electronically transmitting and routing the electronic invoice to the customer and a processing center.

19. The method to capture of magnetic data to create an electronic invoice of claim 17 further comprising, once the electronic invoice is created and an automated clearing house payment is received, processing the payment by opening an electronic form with the appropriate fields required to create an Electronic Payments Association NACHA formatted debit transaction, and electronically transmitting and routing the electronic invoice to the customer.

20. The method to capture of magnetic data to create an electronic invoice of claim 17 further comprising, once the invoice is created and a cash payment is received, processing the payment by transmitting the invoice to the customer and showing that the transaction was completed with a cash payment.

21. The method to capture magnetic data to create an electronic invoice of claim 2.1 further comprising, once the electronic invoice is created and a check payment is received, processing the payment by electronically routing the check information to the clearing institution's electronic exchange system and showing the transaction was completed with a check payment.

22. The method to capture magnetic data to create an electronic invoice of claim 17 further comprising, once the electronic invoice is created and an electronic payment order (EPO) is received, processing the payment by electronically routing the electronic payment order (EPO) information to the clearing institution's electronic exchange system and showing the transaction was completed with an electronic payment order (EPO) payment.

23. The method to capture of magnetic data to create an electronic invoice of claim 16 further including, before capturing payment data, requiring user credentials.

24. The method to capture magnetic data to create an electronic invoice of claim 16 further including allowing a user to correct information containing either misread characters or characters that could not be read.

25. The method to capture of magnetic data to create an electronic invoice of claim 16 further comprising, prior to electronically transmitting the electronic invoice, encrypting the data.

26. The method to capture of magnetic data to create an electronic invoice of claim 16 further comprising exporting data to third-party accounting software applications.
